(19) United States
(12) Patent Application Publication
(10) Pub. No.: US 2007/0009704 A1
(43) Pub. Date: Jan. 11, 2007

(54) Louvre blade with covering applied thereto

(76) Inventor: Edward Coppo, Coorparoo (AU)

Correspondence Address: CANTOR COLBURN, LLP, 55 GRIFFIN ROAD SOUTH, BLOOMFIELD, CT, 06002, US

(21) Appl. No.: 11/357,388

(22) Filed: Feb. 17, 2006

(30) Foreign Application Priority Data
Feb. 18, 2005 (AU) 2005200734

(51) Int. Cl. B32B 1/04

(52) U.S. Cl. 428/76; 428/60; 428/151

(57) ABSTRACT

A louvre blade having a core and a covering to cover at least a part of the core, wherein the covering is bonded to the core of the louvre blade.

### FIELD OF THE INVENTION

The present invention relates to louvre blades and in particular to louvre blades and methods for their construction more cost effectively whilst retaining the functionality of conventional louvre blades.

### BACKGROUND ART

At present, louvre blades are generally manufactured from either glass, aluminium or wood. Glass blades are more common than wooden and aluminium blades due mainly to cost considerations but wooden louvre blades may be preferred by users for the aesthetic value.

Glass and aluminium blades are typically approximately 6 mm in thickness (FIGS. 1 and 2) whilst wooden blades are generally approximately 14 mm thick (FIG. 3). The extra thickness of wooden blades is required to achieve similar strength and rigidity to the same size (but not thickness) glass and aluminium louvre blades.

This means that depending upon the actual species of wood used to manufacture wooden louvre blades, the material required to make a wooden blade can cost from $25/m² to $100/m².

Further, the blades are held in the louvre window assembly by end clips, the most common of which is the 6 mm end clip as illustrated in FIG. 4. Due to the increased thickness of the wooden blade compared to the more common glass blade, a special end clip with a 14 mm opening therein must be used to retain a wooden louvre blade. Alternatively, the end of a wooden blade may undergo size reduction from 14 mm down to 6 mm so that it can be retained in a 6 mm clip.

One alternative to using timber blades is available through the use of aluminium painted in a manner that provides the appearance of wooden grain. However, aluminium blade material painted in this manner costs approximately $60/m².

In general, opaque louvre blades are currently produced using one of three methods, namely:
1. Timber blades, either coated or uncoated;
2. Aluminium, either painted or anodized; or
3. Glass with special finishes, such as frosting or waviness applied to the surface of the glass.

The disadvantages of the conventional louvre blade types are mainly to do with cost and the need to fit standard fittings whilst retaining the strength and rigidity needed to be used as a louvre blade.

It will be clearly understood that, if a prior art publication is referred to herein, this reference does not constitute an admission that the publication forms part of the common general knowledge in the art in Australia or in any other country.

### SUMMARY OF THE INVENTION

The present invention is directed to a louvre blade, which may at least partially overcome at least one of the abovementioned disadvantages or provide the consumer with a useful or commercial choice.

In one form, the invention resides in a louvre blade having a core and a covering to cover at least a part of the core, wherein the covering is bonded to the core of the louvre blade.

The louvre blade and/or core will generally have a pair of main faces on either side of the louvre blade with a pair of end edges and a pair of side edges extending between the main faces.

The core material used may be made of: veneer (softwood or hardwood, which may be of a different species than the panel face), lumber, medium density fiberboard (MDF), plastic, glass, particleboard, other composite panels, aluminium, steel or any combination of these core materials. Blades made with the various core types may differ from one another with respect to certain properties such as flatness, dimensional stability, bending strength, and visual edge quality. The relative importance of specific properties in a particular application of the product help determine the appropriate core type that should be used.

The core will typically be a planar louvre blade member and will be generally rectangular. The core will usually be manufactured from a rigid material.

The covering will typically be applied as a flexible, settable or curable form to the core. When applied, the covering preferably cures to form a barrier having at least one of the following properties:
1. continuous,
2. at least partially flexible,
3. penetration resistant; and
4. opaque.

The covering preferably bonds to the core, preferably by adhesion to an outer surface of the core. The covering may be bonded to the core using other mechanisms for example by embedding the covering in a resinous material which bonds to the core or by other means.

The covering preferably completely encases the core by surrounding both main faces of the louvre together with both end edges and both side edges. Preferably, once the covering is applied to the core, the thickness of the core and the covering bonded thereto remains at approximately 6 mm.

Preferred covering types include powder coating material, settable resin and most preferably, paint. These materials are suitably all applied in an at least partially liquid form and then they harden/set/dry to form a barrier. Where a material such as paint or the like is used, one or more finishing or protective layers may be applied to the paint layer.

Another particularly preferred covering type may be a wooden veneer material. The wooden veneer is generally a thin sheet of a material. It will generally be provided as a layer of wood of superior value or excellent grain to be applied to the core. It may be a protective or ornamental facing (as of brick or stone). Several layers of veneer (generally five or seven) may be used together. The grain direction may differ between the different layers. Glue may be used between the layers.

In a preferred form, the wooden veneer is applied to the main faces of the louvre core only. It is possible to apply the wooden veneer to the edges of the louvre core, however the thickness of the core may present difficulties in doing so. The veneer layers are normally bonded to the core using an adhesive. Embedding the veneer layers in resin is an alternative method. One or more finishing or protective layers may be applied to the veneer layers.

In a second form, the invention resides in a louvre blade having a glass core and an at least partially opaque covering to cover at least a part of the glass core, wherein the covering is bonded to the glass core of the louvre blade.

By providing a glass core, the louvre blade is created that is stiffer that aluminium and provides better waterproofing over the length of the blade-to-blade contact. Glass is also less susceptible to corrosion than aluminium.

In a third form, the invention resides in a louvre blade having a core and a wooden veneer covering to cover at least a part of the core, wherein the wooden veneer covering is bonded to the core of the louvre blade.

### BRIEF DESCRIPTION OF THE DRAWINGS

Various embodiments of the invention will be described with reference to the following drawings, in which:

FIG. 1 is a perspective view of a glass louvre blade.

FIG. 2 is a perspective view of an aluminium louvre blade.

FIG. 3 is a perspective view of a wooden louvre blade.

FIG. 4 is an end elevation view of a standard 6 mm end clip.

FIG. 5 is an end elevation view of a 14 mm end clip used for wooden louvre blades.

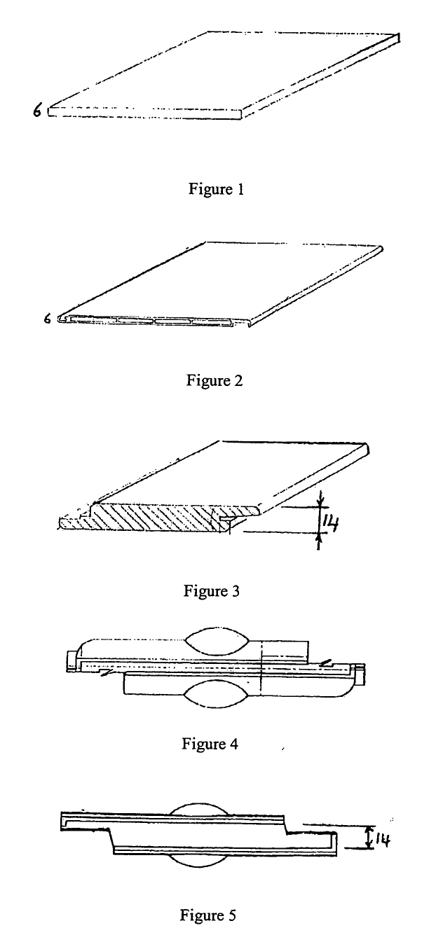

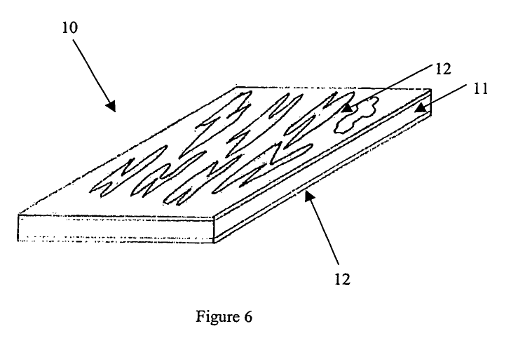

### DETAILED DESCRIPTION OF THE PREFERRED EMBODIMENT

According to a first preferred embodiment of the invention, a louvre blade with a glass core and a paint covering applied thereto is provided.

According to this embodiment, the glass core of the louvre blade will be a conventional glass louvre blade. The core may then be painted using an opaque paint by dipping or spraying the core or by any other mechanism so that, when the paint is dry, the paint bonds to the glass and forms a continuous barrier layer over the core. Due to the thinness of the paint layer, the finished louvre blade has only a negligibly greater thickness than the glass louvre blade to begin with.

According to a second preferred embodiment of the invention, a louvre blade 10 with a glass core 11 and a wooden veneer covering 12 applied to each side thereof is provided.

The wooden veneer louvre blade, as seen in FIG. 6, once again has a glass core 11 which is a conventional glass louvre blade. Once the glass blade is finished, a pair of wooden veneer layers 12 are applied one on either main face of the glass louvre core 11. The wooden veneer layers 12 are approximately the same size as the main faces of the core 11. The wooden veneer layers 12 are bonded to the glass core 11 using an adhesive. Further finishing layers of material such as resin to protect the wooden veneer layers are then applied.

In the present specification and claims, the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

1. A louvre blade having a rigid core and a covering to cover at least a part of the core, wherein the covering is permanently bonded to the core of the louvre blade and is at least partially opaque.

2. A louvre blade according to claim 1, wherein the covering is a wooden veneer covering to cover at least a part of the core, wherein the wooden veneer covering is bonded to the core of the louvre blade.

3. A louvre blade according to claim 1, wherein the core has a pair of main faces on either side of the louvre blade with a pair of end edges and a pair of side edges extending between the main faces.

4. A louvre blade according to claim 1, wherein the core material used is plastic or glass.

5. A louvre blade according to claim 1, wherein the covering is applied to the core in a flexible, settable or curable form which after application, cures to form a barrier.

6. A louvre blade according to claim 1, wherein the covering is opaque.

7. A louvre blade according to claim 1, wherein the covering completely encases the core.

8. A louvre blade according to claim 1, wherein the covering is at least one layer of paint.

9. A louvre blade according to claim 1, wherein the covering is at least one layer of a wooden veneer material.

10. A louvre blade according to claim 9, wherein the wooden veneer is applied to at least one main face of the louvre core.

11. A louvre blade according to claim 9, wherein the wooden veneer is bonded to the core using an adhesive.

12. A louvre blade substantially as hereinbefore described with reference to the accompanying drawings.
